(19) United States
(12) Patent Application Publication
(10) Pub. No.: US 2025/0202236 A1
(43) Pub. Date: Jun. 19, 2025

(54) APPARATUS AND METHOD FOR SUPPLYING POWER TO A LOAD

(71) Applicant: Hitachi Energy Ltd, Zürich (CH)

(72) Inventors: Jean-Philippe HASLER, Västerås (SE); Jon RASMUSSEN, Västra Frölunda (SE)

(21) Appl. No.: 18/849,179

(22) PCT Filed: Mar. 25, 2022
(86) PCT No.: PCT/EP2022/057967

§ 371 Date: Sep. 20, 2024

(51) Int. Cl. H02J 3/14

(52) U.S. Cl. CPC H02J 3/14

(57) ABSTRACT

An apparatus is configured to supply power to a load connected with a power system, which load is connected/connectable to a load conductor. The apparatus comprises a reactor connected/connectable between the power system and the load conductor and a power supplying and/or absorbing device for selectively supplying power to or absorbing power from the load conductor. The apparatus comprises a processing unit configured to, based on values indicative of voltage supplied by the power system and voltage of the load, respectively, at a plurality of time instants determine primary and secondary side voltage differences and based thereon determine a virtual impedance of the device. The apparatus comprises a control unit configured to, based on value(s) indicative of voltage of the load conductor and the virtual impedance, determine a voltage reference value for the device based on which device is controlled to supply power to the load.

### TECHNICAL FIELD

The present invention generally relates to power transmission. More specifically, the present invention relates to an apparatus configured to supply power to a load that is connected with a power system.

### BACKGROUND

A power system, such as a power transmission and/or distribution system and/or a power grid, may be used to provide power to equipment in many industries. In case of occurrence of a disturbance or fault in the power system, the voltage in the power system may experience a dip, or sag, in relation to the nominal voltage level in the power system. Such voltage dips or sags in the power system that may be caused by external disturbances or faults can cause problems for the equipment in many industries, especially in the process industry which often use relatively sensitive loads. Loads such as frequency converters, drive units, etc., are often used in the paper industry, the medical industry, semiconductor manufacturing industry, etc., and are generally dependent on a stable supply voltage, and can in that sense be considered as relatively ‘sensitive’ loads. Supply voltage dips or sags, even if only brief, caused by external disturbances or faults can cause operation of such loads to stop unexpectedly. Such stops in operation may be costly for the users of the loads. A device such as a Static Synchronous Compensator (STATCOM) can be used to provide or absorb reactive power and thereby regulate the voltage at the point of connection to the power system. However, brief supply voltage dips or sags as mentioned above may be difficult to mitigate with a conventional STATCOM, as the response time of such a STATCOM may not be sufficiently low to be able to compensate for the voltage dips or sags quickly enough. Further, such brief supply voltage dips or sags may be difficult or even impossible to compensate based on load current, as the disturbance or fault is caused externally.

### SUMMARY

In order to mitigate any dips or sags in supply voltage for a load connected to a power system which supplies voltage to the load, voltage of the power system may be controlled by measuring voltage and regulating the voltage of the power system towards a certain voltage setpoint using a control loop mechanism that employs a controller such as a proportional integral (PI) controller based on the measured voltage. However, such “traditional” voltage control may still have a response time that is not low enough to be able to compensate for any dips or sags in supply voltage for a load as quickly as required by the load. As mentioned, loads such as frequency converters, drive units, etc., which often are used in the paper industry, the medical industry, semiconductor manufacturing industry, etc., are generally dependent on a stable supply voltage.

In view of the foregoing, a concern of the present invention is to provide means capable of relatively quickly mitigating any dips or sags in supply voltage for a load, particularly a load that may be dependent on a stable supply voltage as described in the foregoing.

To address at least one of this concern and other concerns, an apparatus and a method in accordance with the independent claims are provided. Preferred embodiments are defined by the dependent claims.

According to a first aspect of the present invention, an apparatus is provided. The apparatus is configured to supply power to a load connected with a power system, which load is connected or connectable to a load conductor. The apparatus may comprise a transformer, and the power system may be connected or connectable to the load conductor via the transformer. The apparatus comprises a reactor connected or connectable between the power system (or the transformer) and the load conductor. The apparatus comprises a power supplying and/or absorbing device connected to the load conductor and configured for selectively supplying power to the load conductor or absorbing power from the load conductor. The power supplied to the load conductor by the power supplying and/or absorbing device is governed at least by a voltage reference value of the power supplying and/or absorbing device. The apparatus comprises a processing unit, which is configured to obtain values indicative of voltage supplied by the power system and voltage of the load, respectively, at a plurality of different time instants. The processing unit is configured to, based on the values indicative of voltage supplied by the power system and voltage of the load, respectively, at the plurality of different time instants, determine a primary side voltage difference and a secondary side voltage difference. The primary side voltage difference is representative of any difference in voltage supplied by the power system at different time instants. The secondary side voltage difference is representative of any difference in voltage of the load at the different time instants. The processing unit is configured to determine a virtual impedance of the power supplying and/or absorbing device based on the primary side voltage difference and the secondary side voltage difference. The apparatus comprises a control unit, which is configured to control the power supplying and/or absorbing device. The control unit is configured to obtain at least one value indicative of voltage of the load conductor. The control unit is configured to determine, based on the at least one value indicative of voltage of the load conductor and the virtual impedance, a voltage reference value for the power supplying and/or absorbing device. The control unit is configured to control the power supplying and/or absorbing device to supply power to the load conductor, and thereby to the load, based on the determined voltage reference value.

The reactor that is connected or connectable between the power system and the load conductor may be referred to as a buffer reactor, which generally may be used to provide a higher impedance between the power system and the load conductor. According to one or more embodiments of the present invention, the power supplying and/or absorbing device, which may be directly connected to the load conductor, can be said to use grid forming control to appear as a voltage source behind a virtual impedance. This may be comparable to the function of a synchronous condenser system.

By means of the apparatus according to the first aspect of the present invention, any dip or sag in supply voltage for the load may relatively quickly be compensated for by supply of power to the load by the power supplying and/or absorbing device. In case of a disturbance or fault occurring in the power system a dip or sag in voltage in the power system may occur, which may result in drop in voltage supplied by the power system and in voltage of the load. Such drop in voltage supplied by the power system and in voltage of the load will be reflected in the primary side voltage difference and the secondary side voltage difference which are determined by the control and/or processing unit and used by the control and/or processing unit to determine the virtual impedance of the power supplying and/or absorbing device. As mentioned, the primary side voltage difference is representative of any difference in voltage supplied by the power system at different time instants, and the secondary side voltage difference is representative of any difference in voltage of the load at the different time instants. Once the virtual impedance of the power supplying and/or absorbing device has been determined, it can then be used as described in the foregoing for controlling the power supplying and/or absorbing device to supply power to the load in order to compensate for the dip or sag in supply voltage for the load. Such virtual impedance-based controlling of the power supplying and/or absorbing device may have a response time that is (much) lower than the response time of “traditional” voltage control. By such virtual impedance-based controlling of the power supplying and/or absorbing device, the power supplying and/or absorbing device may be able to counteract dip or sag in supply voltage for the load in a few milliseconds, for all types of faults or disturbances that may occur in the power system. A response time of a few milliseconds is generally (much) lower than the response time that can be achieved by “traditional” voltage control. By such virtual impedance-based controlling of the power supplying and/or absorbing device, all phases may be controlled independently of each other, and any over-voltages caused by positive-sequence control may be avoided.

Further, by virtual impedance-based controlling of the power supplying and/or absorbing device as per the operations of the apparatus according to the first aspect of the present invention, there may be less or even no need for any energy storage or uninterruptible power supply to support the load during a disturbance or fault that may occur in the power system. Further, there may be less or even no need for additional reactive power compensation and power quality correction equipment.

The load conductor may for example comprise a bus, or busbar. The power system may for example comprise a power transmission and/or distribution system. The power system may for example comprise a power grid, e.g., a power transmission and/or distribution grid.

The voltage reference value may be determined by multiplying the sensed voltage of the load conductor with the virtual impedance. Controlling of the power supplying and/or absorbing device to supply power to the load based on the determined voltage reference value may comprise regulating or controlling the voltage output by the power supplying and/or absorbing device such that the output voltage conforms with, or comes closer to conforming with, the voltage reference value, e.g., by means of comparison of the voltage of the load conductor with the voltage reference value. In connection with the controlling of the power supplying and/or absorbing device to supply power to the load (e.g., during such controlling), voltage supplied by the power system (e.g., voltage on the primary side of the transformer) may be sensed (e.g., monitored) in order to assess the effectiveness of the compensation for dip or sag in supply voltage for the load by means of the power supplied to the load by the power supplying and/or absorbing device.

According to a second aspect of the present invention, a method, implemented in an apparatus configured to supply power to a load connected with a power system, is provided. The load is connected or connectable to a load conductor. The apparatus may comprise a transformer, and the power system may be connected or connectable to the load conductor via the transformer. The apparatus comprises a reactor, connected or connectable between the power system (or the transformer) and the load conductor. The apparatus comprises a power supplying and/or absorbing device, which is connected to the load conductor and configured for selectively supplying power to the load conductor or absorbing power from the load conductor. The power supplied to the load conductor by the power supplying and/or absorbing device is governed at least by a voltage reference value of the power supplying and/or absorbing device. The apparatus comprises a processing unit. The apparatus comprises a control unit configured to control the power supplying and/or absorbing device.

The method according to the second aspect of the present invention comprises, by the processing unit, obtaining values indicative of voltage supplied by the power system and voltage of the load, respectively, at a plurality of different time instants. Based on the values indicative of voltage supplied by the power system and voltage of the load, respectively, at the plurality of different time instants, a primary side voltage difference representative of any difference in voltage supplied by the power system at different time instants and a secondary side voltage difference representative of any difference in voltage of the load at the different time instants are determined by the processing unit. A virtual impedance of the power supplying and/or absorbing device is determined by the processing unit based on the primary side voltage difference and the secondary side voltage difference. At least one value indicative of voltage of the load conductor is obtained by the control unit. Based on the at least one value indicative of voltage of the load conductor and the virtual impedance, a voltage reference value for the power supplying and/or absorbing device is determined by the control unit. The power supplying and/or absorbing device is controlled by the control unit to supply power to the load conductor, and thereby to the load, based on the determined voltage reference value.

According to a third aspect of the present invention, a computer program is provided. The computer program comprises instructions, which when executed by one or more processors comprised in a processing unit and in a control unit, respectively, cause the processing unit and the control unit to perform a method according to the second aspect of the present invention.

According to a fourth aspect of the present invention, a processor-readable medium is provided. The processor-readable medium has a computer program loaded thereon, wherein the computer program comprises instructions, which, when executed by one or more processors comprised in or constituting a processing unit and one or more processors comprised in or constituting a control unit, cause the processing unit and the control unit to perform a method according to the second aspect of the present invention.

According to a fifth aspect of the present invention, a system is provided. The system comprises a power system, a load connected with the power system, and a load conductor. The load is connected or connectable to the load conductor. The system may comprise a transformer, and the power system may be connected or connectable to the load conductor via the transformer. The system comprises an apparatus according to the first aspect of the present invention, which apparatus is configured to supply power to the load.

It is to be noted that the functionalities of the processing unit and the control unit referred to herein could possibly be combined in a single unit, for example such that a single unit may be capable of carrying out the respective actions, functions, etc., of the processing unit and the control unit. Such a unit could be referred to as a control and/or processing unit. In other words, the processing unit and the control unit referred to herein must not necessarily be separate units, but could in principle be realized or implemented by a single unit.

Each or any of the control unit and the processing unit may for example include or be constituted by any suitable central processing unit (CPU), microcontroller, digital signal processor (DSP), Application Specific Integrated Circuit (ASIC), Field Programmable Gate Array (FPGA), etc., or any combination thereof. Each or any of the control unit and the processing unit may optionally be capable of executing software instructions stored in a computer program product, e.g., in the form of a memory. The memory may for example be any combination of read and write memory (RAM) and read only memory (ROM). The memory may comprise persistent storage, which for example can be a magnetic memory, an optical memory, a solid-state memory or a remotely mounted memory, or any combination thereof.

Each or any of the one or more processors may for example comprise a CPU, a microcontroller, a DSP, an ASIC, an FPGA, etc., or any combination thereof.

The processor-readable medium may for example include a Digital Versatile Disc (DVD) or a floppy disk or any other suitable type of processor-readable means or processor-readable (digital) medium, such as, but not limited to, a memory such as, for example, nonvolatile memory, a hard disk drive, a Compact Disc (CD), a Flash memory, magnetic tape, a Universal Serial Bus (USB) memory device, a Zip drive, etc.

Further objects and advantages of the present invention are described in the following by means of exemplifying embodiments. It is noted that the present invention relates to all possible combinations of features recited in the claims. Further features of, and advantages with, the present invention will become apparent when studying the appended claims and the description herein. Those skilled in the art realize that different features of the present invention can be combined to create embodiments other than those described herein.

### BRIEF DESCRIPTION OF THE DRAWINGS

Exemplifying embodiments of the present invention will be described below with reference to the accompanying drawings.

FIG. 1 is a schematic view of a system according to an embodiment of the present invention, the system comprising an apparatus according to an embodiment of the present invention.

FIG. 2 is a schematic flowchart of a method according to an embodiment of the present invention.

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments are provided by way of example so that this disclosure will convey the scope of the present invention to those skilled in the art.

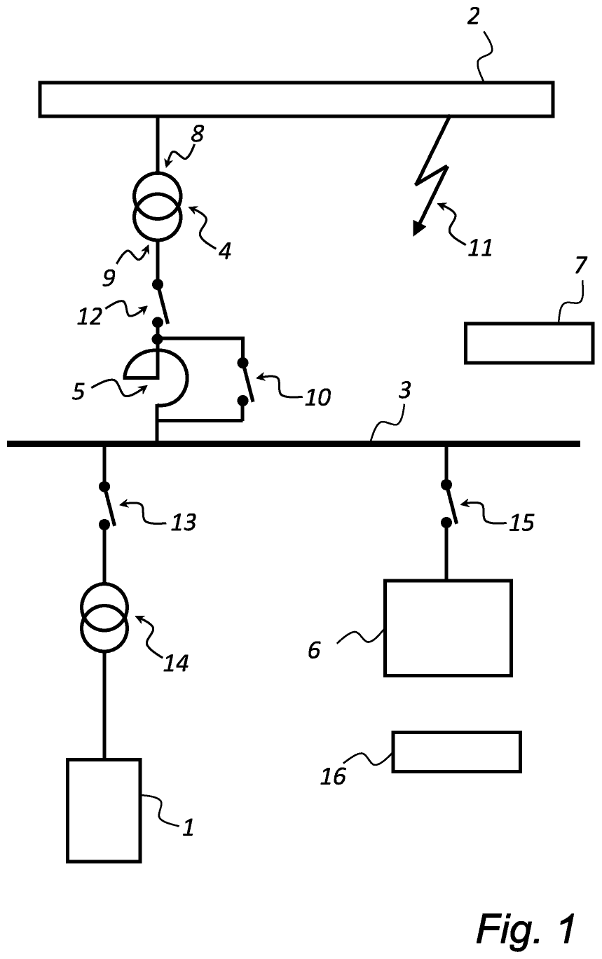

FIG. 1 is a schematic view of a system according to an embodiment of the present invention, which system comprises an apparatus according to an embodiment of the present invention. In accordance with the embodiment illustrated in FIG. 1, the system comprises a power system 2, a transformer 4, a load 1 that is connected with the power system 2, and a load conductor 3. The load 1 is connected or connectable to the load conductor 3, possibly via a transformer 14. The transformer 14 may be omitted. The power system 2 is connected or connectable to the load conductor 3 via the transformer 4. The load conductor 3 may for example comprise a bus, or busbar. The power system 2 may for example comprise a power transmission and/or distribution system. The power system 2 may for example comprise a power grid, e.g., a power transmission and/or distribution grid. The load 1 may for example be a frequency converter, a drive unit, etc., used in the paper industry, the medical industry, semiconductor manufacturing industry, but is not limited thereto. The transformer 4 is connected between the power system 2 and the load 1, and as such the transformer 4 could, according to one or more embodiments of the present invention, be referred to (or comprising) as a step-down transformer. The transformer 14 may be referred to as a load transformer.

As illustrated in FIG. 1, the power system 2 may be connectable to the load conductor 3 via the transformer 4 by means of a switch 12, which may be normally closed (e.g., so that the switch 12 conducts current therethrough) when or whenever the load 1 is in operation. As further illustrated in FIG. 1, the load 1 may be connectable to the load conductor 3 by means of a switch 13, which may be normally closed (e.g., so that the switch 13 conducts current therethrough) when or whenever the load 1 is in operation.

The system comprises an apparatus that is configured to supply power to the load 1 connected with the power system 2. The apparatus may be configured to supply power to the load 1, e.g., in addition to any power supplied to the load 1 from the power system 2, in case of a disturbance or fault occurring in the power system 2 causing a dip or sag in voltage in the power system 2 which may result in drop in voltage supplied by the power system 2 and in voltage of the load 1.

The apparatus comprises a reactor 5 connected or connectable between the power system 2 and the load conductor 3.

The apparatus comprises a power supplying and/or absorbing device 6. The power supplying and/or absorbing device 6 is connected to the load conductor 3 and is configured for selectively supplying power to the load conductor 3 or absorbing power from the load conductor 3. The power supplied to the load conductor 3 by the power supplying and/or absorbing device 6 is governed at least by a voltage reference value of the power supplying and/or absorbing device 6.

The apparatus comprises a processing unit 7 and a control unit 16. The apparatus will in the following be referred to collectively with reference numerals 5, 6, 7, 16. The transformer 4 may also be considered to be comprised in the apparatus.

The processing unit 7 is configured to obtain values indicative of voltage supplied by the power system 2 and voltage of the load 1, respectively, at a plurality of different time instants. To that end, the processing unit 7 may for example be configured to retrieve or receive the values indicative of voltage supplied by the power system 2 and voltage of the load 1, respectively, from at least one sensor (not shown in FIG. 1), which may be configured to sense voltage supplied by the power system 2 and voltage of the load 1, respectively, at a plurality of different time instants. Thus, the values indicative of voltage supplied by the power system 2 and voltage of the load 1, respectively, may be (e.g., sensed) values of voltage supplied by the power system 2 and voltage of the load 1, respectively. The values indicative of voltage supplied by the power system 2 and voltage of the load 1, respectively, are not limited to sensed voltage supplied by the power system 2 and voltage of the load 1, respectively, but could possibly be derived from some other sensed or measured quantity.

Although FIG. 1 illustrates a current path between the power system 2 and the load conductor 3 including the transformer 4 and the reactor 5, it is to be understood that the transformer 4 could be omitted in the current path.

The at least one sensor may possibly be considered to be comprised in the apparatus 5, 6, 7, 16, or it may be another part of the said system. There may be a single sensor configured to sense both voltage supplied by the power system 2 and voltage of the load 1, or there may be separate sensors configured to sense voltage supplied by the power system 2 and voltage of the load 1, respectively.

For example, the values indicative of voltage supplied by the power system 2 at the plurality of different time instants may be values indicative of voltage at the primary side 8 of the transformer 4 at the plurality of different time instants, and the values indicative of voltage of the load 1 at the plurality of different time instants may be values indicative of voltage at the secondary side 9 of the transformer 4 at the plurality of different time instants. Thus, the at least one sensor may be configured to sense voltage at the primary side 8 of the transformer 4 and voltage at the secondary side 9 of the transformer 4, respectively, at a plurality of different time instants. Accordingly, the values indicative of voltage at the primary side 8 of the transformer 4 at the plurality of different time instants, and the values indicative of voltage at the secondary side 9 of the transformer 4 at the plurality of different time instants may be values of (e.g., sensed) voltage at the primary side 8 of the transformer 4 and voltage at the secondary side 9 of the transformer 4, respectively, However, the values indicative of voltage at the primary side 8 of the transformer 4 at the plurality of different time instants, and the values indicative of voltage at the secondary side 9 of the transformer 4 at the plurality of different time instants are not limited to sensed voltage at the primary side 8 of the transformer 4 and voltage at the secondary side 9 of the transformer 4, respectively, but could possibly be derived from some other sensed or measured quantity.

The primary side 8 of the transformer 4 may in alternative be referred to as the power system side of the transformer 4, and the secondary side 9 of the transformer 4 may in alternative be referred to as the load side of the transformer 4.

The processing unit 7 is configured to, based on the values indicative of voltage supplied by the power system 2 and voltage of the load 1, respectively, at the plurality of different time instants, determine a primary side voltage difference ΔV_{primary} and a secondary side voltage difference ΔV_{secondary}. The primary side voltage difference ΔV_{primary} is representative of any difference in voltage supplied by the power system 2 at different time instants. The secondary side voltage difference ΔV_{secondary} is representative of any difference in voltage of the load 1 at the different time instants.

The primary side voltage difference ΔV_{primary} representative of any difference in voltage supplied by the power system 2 at different time instants may comprise a difference between voltage supplied by the power system 2 at one time instant of the different time instants and voltage supplied by the power system 2 at another time instant of the different time instants. However, the primary side voltage difference ΔV_{primary} representative of any difference in voltage supplied by the power system 2 at different time instants could be determined in another or other ways, such as, for example, by determining several values of difference between voltages supplied by the power system 2 at different time instants and taking an average of the several values.

Similarly, the secondary side voltage difference ΔV_{secondary} representative of any difference in voltage of the load 1 at different time instants may comprise a difference between voltage of the load 1 at one time instant of the different time instants and voltage of the load 1 at another time instant of the different time instants. However, the secondary side voltage difference ΔV_{secondary} representative of any difference in voltage of the load 1 at different time instants could be determined in another or other ways, such as, for example, by determining several values of difference between voltages of the load 1 at different time instants and taking an average of the several values.

The processing unit 7 is configured to determine a virtual impedance Zᵥᵢᵣₜᵤₐₗ of the power supplying and/or absorbing device 6 based on the primary side voltage difference ΔV_{primary} and the secondary side voltage difference ΔV_{secondary}. For example, the processing unit 7 may be configured to determine the virtual impedance Zᵥᵢᵣₜᵤₐₗ based on a ratio between the primary side voltage difference ΔV_{primary} and the secondary side voltage difference ΔV_{secondary}, e.g., ΔV_{primary}/ΔV_{secondary}, which ratio may be referred to as a damping factor.

In case of a disturbance or fault occurring in the power system 2, schematically indicated at 11 in FIG. 1, a dip or sag in voltage in the power system 2 may occur, which may result in drop in voltage supplied by the power system 2 and in voltage of the load 1. Such drop in voltage supplied by the power system 2 and in voltage of the load 1 will be reflected in the primary side voltage difference ΔV_{primary} and the secondary side voltage difference ΔV_{secondary} which are determined by the processing unit 7 and used by the processing unit 7 to determine the virtual impedance Zᵥᵢᵣₜᵤₐₗ of the power supplying and/or absorbing device 6.

As mentioned, the values indicative of voltage supplied by the power system 2 at the plurality of different time instants may for example be values indicative of voltage at the primary side 8 of the transformer 4 at the plurality of different time instants, and the values indicative of voltage of the load 1 at the plurality of different time instants may be values indicative of voltage at the secondary side 9 of the transformer 4 at the plurality of different time instants. In that case, the processing unit 7 may be configured to determine the primary side voltage difference ΔV_{primary} and the secondary side voltage difference ΔV_{secondary} based on the values indicative of voltage at the primary side 8 of the transformer 4 at the plurality of different time instants and the values indicative of voltage at the secondary side 9 of the transformer 4 at the plurality of different time instants, respectively. The primary side voltage difference ΔV_{primary} representative of any difference in voltage at the primary side 8 of the transformer 4 at different time instants may comprise a difference between voltage at the primary side 8 of the transformer 4 at one time instant of the different time instants and voltage at the primary side 8 of the transformer 4 at another time instant of the different time instants. However, the primary side voltage difference ΔV_{primary} representative of any difference in voltage at the primary side 8 of the transformer 4 at different time instants could be determined in another or other ways, such as, for example, by determining several values of difference between voltages on the primary side 8 of the transformer 4 at different time instants and taking an average of the several values. Similarly, the secondary side voltage difference ΔV_{secondary} representative of any difference in voltage at the secondary side 9 of the transformer 4 at different time instants may comprise a difference between voltage at the secondary side 9 of the transformer 4 at one time instant of the different time instants and voltage at the secondary side 9 of the transformer 4 at another time instant of the different time instants. However, the secondary side voltage difference ΔV_{secondary} representative of any difference in voltage at the secondary side 9 of the transformer 4 at different time instants could be determined in another or other ways, such as, for example, by determining several values of difference between voltages on the secondary side 9 of the transformer 4 at different time instants and taking an average of the several values.

The control unit 16 is configured to control the power supplying and/or absorbing device 6.

The control unit 16 is configured to obtain at least one value indicative of voltage of the load conductor 3. To that end, the control unit 16 may for example be configured to retrieve or receive at least one value indicative of voltage of the load conductor 3 from the at least one sensor, which may be (e.g., further) configured to sense a voltage of the load conductor 3. Thus, the at least one value indicative of voltage of the load conductor 3 may be at least one value of (e.g., sensed) voltage of the load conductor 3. The at least one value indicative of voltage of the load conductor 3 is not limited to sensed voltage of the load conductor 3, but could possibly be derived from some other sensed or measured quantity.

The control unit 16 is configured to determine, based on the at least one value indicative of voltage of the load conductor 3 and the determined virtual impedance, a voltage reference value for the power supplying and/or absorbing device 6. The control unit 16 is configured to control the power supplying and/or absorbing device 6 to supply power to the load conductor 3, and thereby to the load 1, based on (e.g., utilizing or using) the determined voltage reference value. Thereby, the power supplying and/or absorbing device 6 could be said to use grid forming control to appear as a voltage source behind a virtual impedance. This may be comparable to the function of a synchronous condenser system. The voltage reference value may be determined by multiplying the at least one value indicative of voltage of the load conductor 3 with the virtual impedance.

The processing unit 7 may be configured to determine the virtual impedance Zᵥᵢᵣₜᵤₐₗ of the power supplying and/or absorbing device 6 based on a reactance of the transformer 4 and a reactance of the reactor 5 that is connected or connectable between the power system 2 and the load conductor 3. The processing unit 7 may for example be configured to determine the virtual impedance Zᵥᵢᵣₜᵤₐₗ based on the following relation:

$$Δ {V}_{primary} / Δ {V}_{secondary} = 1 + ( {X}_{transformer} + {X}_{reactor} ) / {X}_{virtual} ,$$

In the relation above, ΔV_{primary} is the primary side voltage difference and ΔV_{secondary} is the secondary side voltage difference as mentioned in the foregoing. Further, X_{transformer} is the reactance of the transformer 4, X_{reactor} is the reactance of the reactor 5 that is connected or connectable between the power system 2 and the load conductor 3, and Xᵥᵢᵣₜᵤₐₗ is the virtual reactance of the power supplying and/or absorbing device 6.

The virtual impedance Zᵥᵢᵣₜᵤₐₗ has a resistive component R and a reactive component that may be provided by the virtual reactance Xᵥᵢᵣₜᵤₐₗ in the relation above. The resistive component R provides damping for approaching or reaching steady-state conditions after occurrence of the disturbance or fault 11 in the power system 2, but may not have any impact on voltage compensation, and may as such be ignored in the relation above. Thereby, the virtual impedance Zᵥᵢᵣₜᵤₐₗ can be determined by means of the relation above, as X_{transformer} and X_{reactor} are ‘known’, depending on the particular choice of the reactor 5 and the transformer 4.

In accordance with the embodiment of the present invention illustrated in FIG. 1, the reactor 5 is a separate component, or a “physical” component, connected or connectable in series with the transformer 4 between power system 2 and the load conductor 3. The reactor 5 may be referred to as a buffer reactor, which generally may provide a higher impedance between the power system 2 and the load conductor 3. It is however to be understood that the reactor 5 must not necessarily be a separate component, or “physical” component, and that it may possibly be represented by, e.g., the reactance of another or other components or circuits. For example, the transformer 4 could be chosen and/or configured so that there is a sufficiently high reactance between the power system 2 and the load conductor 3. Thus, the reactor 5 could for example be embodied by the transformer 4.

The power supplying and/or absorbing device 6 could in alternative be referred to as a power sourcing and/or sinking device.

By the power supplying and/or absorbing device 6 being configured for selectively supplying power to the load conductor 3, and since the load 1 is connected or connectable to the load conductor 3 and the power system 2 is connected or connectable to the load conductor 3 via the transformer 4, the power supplying and/or absorbing device 6 may thereby be used to selectively supply power to the load 1 and/or the power system 2.

Further, by the power supplying and/or absorbing device 6 being configured for selectively absorbing power from the load conductor 3, and since the load 1 is connected or connectable to the load conductor 3 and the power system 2 is connected or connectable to the load conductor 3 via the transformer 4, the power supplying and/or absorbing device 6 may thereby be used for selectively absorbing power from the power system 2 and/or from the load 1.

The power supplying and/or absorbing device 6 may be configured to supply, e.g., controllably supply, power to the load 1 via the load conductor 3.

The power supplying and/or absorbing device 6 may for example comprise or be constituted by a Voltage Source Converter (VSC) based device, a Static Synchronous Compensator (STATCOM) and/or a multi-level converter. For example, the VSC based device may, according to one or more embodiments of the present invention, comprise any VSC based device capable of generating unsymmetric current. The STATCOM may have a delta topology. However, the STATCOM is not limited thereto, and could in alternative have, e.g., a wye topology. The multi-level converter may for example comprise a three-level converter.

The power supplying and/or absorbing device 6 may be directly connected to the load conductor 3, as illustrated in FIG. 1, or indirectly connected to the load conductor 3 (e.g., via one or more intermediate devices or components).

For example, in case the power supplying and/or absorbing device 6 comprises or is constituted by a STATCOM having a delta topology, the power supplying and/or absorbing device 6 may be connected to the load conductor 3 at, or via a conductor connected to, a corner point (e.g., terminal) of the delta topology configured STATCOM.

In accordance with the embodiment of the present invention illustrated in FIG. 1, the apparatus 5, 6, 7, 16 comprises a bypass switch 10 connected in relation to the reactor 5 such that the reactor 5 can be selectively bypassed in a current path between the transformer 4 and the load conductor 3 based on switching of the bypass switch between different operational states thereof. By means of the bypass switch 10, the reactor 5 can be bypassed for example if the power supplying and/or absorbing device 6 is out of service. In case the power supplying and/or absorbing device 6 would be out of service it may be disconnected from the load conductor 3 by means of a switch 15, which may be normally closed (e.g., so that the switch 15 conducts current therethrough) when or whenever the power supplying and/or absorbing device 6 is in service.

As illustrated in FIG. 1, the bypass switch 10 may for example be connected in parallel with the reactor 5.

The operational states of the bypass switch 10 may include at least one non-conducting state of the bypass switch 10 and at least one conducting state of the bypass switch 10. In the context of the present application, by a non-conducting state of the bypass switch 10 it is meant a state where there is no or only very little conduction of current through the bypass switch 10. Thus, the bypass switch 10 may be switchable so as to stop, or substantially stop, the bypass switch 10 from conducting current through the bypass switch 10.

Further in accordance with the embodiment of the present invention illustrated in FIG. 1, the reactor 5 may be connected to the load conductor 3 at a location between the locations where the load 1 is connected or connectable to the load conductor 3 and where the power supplying and/or absorbing device 6 is connected to the load conductor 3.

As mentioned, the control unit 16 is configured to control the power supplying and/or absorbing device 6. To that end, the control unit 16 may be communicatively connected with the power supplying and/or absorbing device 6. The control unit 16 and/or the processing unit 7 may be communicatively connected with another or other components, part, units, modules, etc., of the apparatus 5, 6, 7, 16 or of the said system, such as, for example, the at least one sensor. By the control unit 16 and/or the processing unit 7 being communicatively connected with another component, part, unit, module, etc., it is herein meant that the control unit 16 and/or the processing unit 7 and the other component, part, unit, module, etc. are able to communicate via wired and/or wireless communication means or techniques, for example via any appropriate wired and/or wireless communication means or techniques as known in the art, for transmitting messages, instructions, data, commands, etc., from the control unit 16 and/or the processing unit 7 to the other component, part, unit, module, etc. and possibly vice versa. Wired communication means may for example comprise radio frequency (RF) communication, infrared communication (e.g., employing a communication link employing infrared light) or another type of free-space optical communication. Wireless communication means may for example comprise at least one optical waveguide, or optical transmission line (e.g., an optical fiber), and/or at least one electrical conductor (e.g., a cable or wire, e.g., a copper conductor or cable, or copper wire).

It is to be noted that the functionalities of the processing unit 7 and the control unit 16 could possibly be combined in a single unit, for example such that a single unit may be capable of carrying out the respective actions, functions, etc., of the processing unit 7 and the control unit 16, e.g., such as described in the foregoing with reference to FIG. 1. Such a unit could be referred to as a control and/or processing unit. In other words, the processing unit 7 and the control unit 16 referred to herein must not necessarily be separate units, but could in principle be realized or implemented by a single unit.

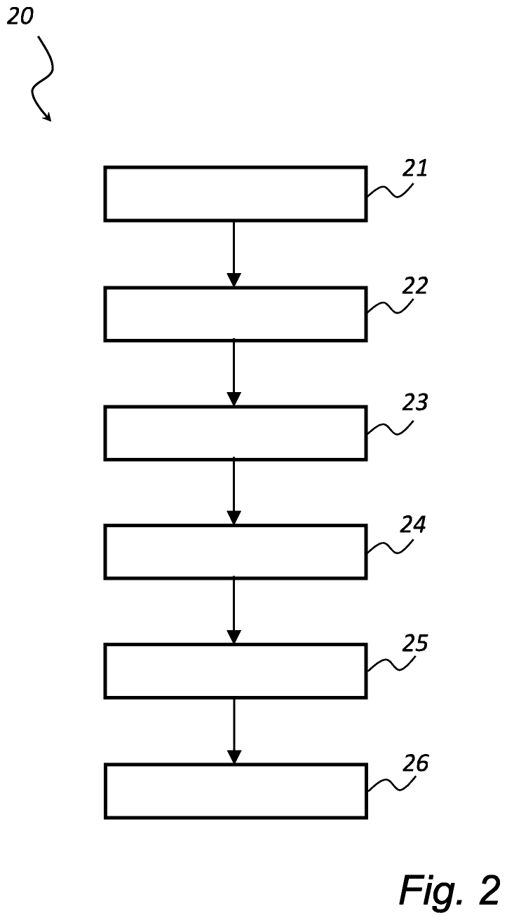

FIG. 2 is a schematic flowchart of a method 20 according to an embodiment of the present invention. The method 20 is implemented in an apparatus configured to supply power to a load connected with a power system. The load is connected or connectable to a load conductor. The apparatus may comprise a transformer, and the power system may be connected or connectable to the load conductor via the transformer. The apparatus comprises a reactor, connected or connectable between the transformer and the load conductor. The apparatus comprises a power supplying and/or absorbing device, which is connected to the load conductor and configured for selectively supplying power to the load conductor or absorbing power from the load conductor. The power supplied to the load by the power supplying and/or absorbing device is governed at least by a voltage reference value of the power supplying and/or absorbing device. The apparatus comprises a processing unit. The apparatus comprises a control unit configured to control the power supplying and/or absorbing device.

The method 20 comprises, at 21 (at which the method 20 may start), the processing unit obtaining values indicative of voltage supplied by the power system and voltage of the load, respectively, at a plurality of different time instant. At 22, based on the values indicative of voltage supplied by the power system and voltage of the load, respectively, at the plurality of different time instants, a primary side voltage difference representative of any difference in voltage supplied by the power system at different time instants and a secondary side voltage difference representative of any difference in voltage of the load at the different time instants are determined by the processing unit. At 23, a virtual impedance of the power supplying and/or absorbing device is determined by the processing unit based on the primary side voltage difference and the secondary side voltage difference. At 24, at least one value indicative of voltage of the load conductor is obtained by the control unit. At 25, based on the at least one value indicative of voltage of the load conductor and the determined virtual impedance, a voltage reference value for the power supplying and/or absorbing device is determined by the control unit. At 26, the power supplying and/or absorbing device is controlled by the control unit to supply power to the load based on the determined voltage reference value. The method may then end.

In conclusion, an apparatus is provided, configured to supply power to a load connected with a power system, which load is connected or connectable to a load conductor. The apparatus comprises a reactor connected or connectable between the power system and the load conductor and a power supplying and/or absorbing device configured for selectively supplying power to or absorbing power from the load conductor. The apparatus comprises a processing unit configured to, based on values indicative of voltage supplied by the power system and voltage of the load, respectively, at a plurality of different time instants determine a primary side voltage difference and a secondary side voltage difference and based thereon determine a virtual impedance of the power supplying and/or absorbing device. The apparatus comprises a control unit configured to, based on at least one value indicative of voltage of the load conductor and the virtual impedance, determine a voltage reference value for the power supplying and/or absorbing device based on which the power supplying and/or absorbing device is controlled to supply power to the load.

While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An apparatus configured to supply power to a load connected with a power system, the load being connected or connectable to a load conductor, the apparatus comprising:
a reactor connected or connectable between the power system and the load conductor;
a power supplying and/or absorbing device connected to the load conductor and configured for selectively supplying power to the load conductor or absorbing power from the load conductor, the power supplied to the load conductor by the power supplying and/or absorbing device being governed at least by a voltage reference value of the power supplying and/or absorbing device; and
a processing unit configured to:
obtain values indicative of voltage supplied by the power system and voltage of the load, respectively, at a plurality of different time instants; and
based on the values indicative of voltage supplied by the power system and voltage of the load, respectively, at the plurality of different time instants, determine a primary side voltage difference, representative of any difference in voltage supplied by the power system at different time instants, and a secondary side voltage difference, representative of any difference in voltage of the load at the different time instants; and
determine a virtual impedance of the power supplying and/or absorbing device based on the primary side voltage difference and the secondary side voltage difference;
the apparatus further comprising a control unit configured to control the power supplying and/or absorbing device, the control unit being further configured to:
obtain at least one value indicative of voltage of the load conductor;
determine, based on the at least one value indicative of voltage of the load conductor and the virtual impedance, a voltage reference value for the power supplying and/or absorbing device; and
control the power supplying and/or absorbing device to supply power to the load conductor, and thereby to the load, based on the determined voltage reference value.

2. An apparatus according to claim 1, wherein the processing unit is configured to determine the virtual impedance further based on a ratio between the primary side voltage difference and the secondary side voltage difference.

3. An apparatus according to claim 1, further comprising a transformer, the power system being connected or connectable to the load conductor via the transformer, wherein the processing unit is configured to determine the virtual impedance based on a reactance of the transformer and a reactance of the reactor that is connected or connectable between the power system and the load conductor.

4. An apparatus according to claim 1, further comprising a transformer, the power system being connected or connectable to the load conductor via the transformer, wherein the processing unit is configured to determine the virtual impedance based on the following relation:
$$Δ {V}_{primary} / Δ {V}_{secondary} = 1 + ( {X}_{transformer} + {X}_{reactor} ) / {X}_{virtual} ,$$
where ΔV_{primary} is the primary side voltage difference, ΔV_{secondary} is the secondary side voltage difference, X_{transformer} is a reactance of the transformer, X_{reactor} is a reactance of the reactor that is connected or connectable between the power system and the load conductor, and Xᵥᵢᵣₜᵤₐₗ is a virtual reactance of the power supplying and/or absorbing device.

5. An apparatus according to claim 1, further comprising a transformer, the power system being connected or connectable to the load conductor via the transformer, wherein the reactor is a separate component connected or connectable in series with the transformer between the power system and the load conductor.

6. An apparatus according to claim 5, further comprising a bypass switch connected in relation to the reactor such that the reactor can be selectively bypassed in a current path between the transformer and the load conductor based on switching of the bypass switch between different operational states thereof.

7. An apparatus according to claim 1, further comprising a transformer, the power system being connected or connectable to the load conductor via the transformer, and wherein the reactor is embodied by the transformer.

8. An apparatus according to claim 1, wherein the power supplying and/or absorbing device comprises or is constituted by a Voltage Source Converter (VSC) based device, a Static Synchronous Compensator (STATCOM), and/or a multi-level converter.

9. An apparatus according to claim 1, wherein the reactor is connected to the load conductor at a location between the locations where the load is connected or connectable to the load conductor and where the power supplying and/or absorbing device is connected to the load conductor.

10. An apparatus according to claim 1, wherein the power supplying and/or absorbing device is directly connected to the load conductor.

11. An apparatus according to claim 1, further comprising a transformer, the power system being connected or connectable to the load conductor via the transformer, wherein the values indicative of voltage supplied by the power system at the plurality of different time instants are values indicative of voltage at the primary side of the transformer at the plurality of different time instants, and the values indicative of voltage of the load at the plurality of different time instants are values indicative of voltage at the secondary side of the transformer at the plurality of different time instants.

12. An apparatus according to claim 11, wherein the processing unit is configured to determine the primary side voltage difference and the secondary side voltage difference based on the values indicative of voltage at the primary side of the transformer at the plurality of different time instants and the values indicative of voltage at the secondary side of the transformer at the plurality of different time instants, respectively.

13. A method implemented in an apparatus configured to supply power to a load connected with a power system, the load being connected or connectable to a load conductor, the apparatus comprising a reactor, connected or connectable between the power system and the load conductor, and a power supplying and/or absorbing device connected to the load conductor and configured for selectively supplying power to the load conductor or absorbing power from the load conductor, the power supplied to the load conductor by the power supplying and/or absorbing device being governed at least by a voltage reference value of the power supplying and/or absorbing device, the apparatus further comprising a processing unit, and the apparatus further comprising a control unit configured to control the power supplying and/or absorbing device, the method comprising, by the processing unit:
obtaining values indicative of voltage supplied by the power system and voltage of the load, respectively, at a plurality of different time instants;
based on the values indicative of voltage supplied by the power system and voltage of the load, respectively, at the plurality of different time instants, determining a primary side voltage difference representative of any difference in voltage supplied by the power system at different time instants and a secondary side voltage difference representative of any difference in voltage of the load at the different time instants; and
determining a virtual impedance of the power supplying and/or absorbing device based on the primary side voltage difference and the secondary side voltage difference;
the method further comprising, by the control unit:
obtaining at least one value indicative of voltage of the load conductor;
determining, based on the at least one value indicative of voltage of the load conductor and the virtual impedance, a voltage reference value for the power supplying and/or absorbing device; and
controlling the power supplying and/or absorbing device to supply power to the load conductor, and thereby to the load, based on the determined voltage reference value.

14. A non-transitory computer-readable medium having a computer program stored thereon, the computer program comprising instructions, which when executed by one or more processors comprised in a processing unit and in a control unit, respectively, cause the processing unit and the control unit to perform the method of claim 13.

15. A system comprising:
a power system;
a load connected with the power system;
a load conductor, wherein the load is connected or connectable to the load conductor; and
an apparatus according to claim 1 configured to supply power to the load.
